(19) United States
(12) Patent Application Publication
(10) Pub. No.: US 2017/0099992 A1
(43) Pub. Date: Apr. 13, 2017

(54) Marinade Appliance

(71) Applicant: Mark Clemens, Lakewood, CO (US)

(72) Inventor: Mark Clemens, Lakewood, CO (US)

(21) Appl. No.: 15/277,116

(22) Filed: Sep. 27, 2016

Related U.S. Application Data
(60) Provisional application No. 62/238,817, filed on Oct. 8, 2015.

(51) Int. Cl. A47J 43/18

(52) U.S. Cl. CPC A47J 43/18

(57) ABSTRACT

A container preferably made of a copper tube can be placed on a barbeque grill. Adjustable sized holes on top allow the chef to adjust how much vapor escapes from the container during a cooking cycle. For washing the copper tube can be broken down in half for insertion into a dishwasher. The cylindrical hollow tube can have a smooth circular cross section or equivalents including octagon, hexagon and rectangular. Equivalents to the cylindrical tube being pulled apart for cleaning include a hinge relationship between two tube segments.

### CROSS REFERENCE APPLICATIONS

This application is a non-provisional application claiming the benefits of provisional application Ser. No. 62/238,817 filed Oct. 8, 2015 which is incorporated herein by reference in its entirety.

### FIELD OF INVENTION

The present invention relates to providing an outdoor barbeque stove with a vaporizing appliance located on top of the grill to add water vapor and/or flavoring vapors into the oven enclosure.

### BACKGROUND OF THE INVENTION

A brief summary of the known prior art follows below.

| Primary U.S. Class | U.S. Patent or App. No. | Inventor |
|---|---|---|
| 99/345 | 6,502,501 | Simon* |
| 99/345 | 6,125,739 | Jernigan* |
| 99/419 | 8,813,636 | Oswald* |
| 99/349 | 6,026,736 | Turner |
| 126/25R | 2010/0206291 | Axinte et al. |
| 99/482 | 2013/0192476 | Broeman |
| 426/281 | 2006/0068067 | Zimmerman* |
| 99/482 | 8,443,722 | Hanson* |

*summarized below

### SUMMARY OF REFERENCES FOUND

The following documents and their synopsis are presented for your review:

1. U.S. Pat. No. 6,502,501 (2003) to Simon discloses an apparatus consisting of a shallow pan and a lid provided with a central opening. The lid supports a hollow, perforated tower to support a poultry. The tower is detachable from the lid and interchangeable with alternate towers. The marinade or liquid in the pan is heated and produces steam that goes out the perforations into the meat.

2. U.S. Pat. No. 6,125,739 (2000) discloses an apparatus with a frustoconical fluid chamber insert which is perforated fitted to a base for marinating a poultry. Heat produces steam that infuses into the meat.

3. U.S. Pat. No. 8,813,636 (2014) discloses a food cooker to cook and infuse skewered food with multiple perforated spines adjustably positionable on a sealable support chamber that houses marinade.

4. U.S. App. No. 2006/0068067 (2006) discloses a device and method for infusing heated liquid into an item being cooked including infusers to penetrate food item and a fluid reservoir at a remote location with a connecting conduit.

5. U.S. Pat. No. 6,026,736 (2000) discloses a grill with a cooking surface with grooves from which vapor from a heated fluid from a marinade cup is channeled to steam the food and drain fat.

6. U.S. App. No. 2006/0068067 now U.S. Pat. No. 7,549,369 describes a device and method for infusing a heated fluid into an item being cooked. The device includes infusers that are multiple pointed stakes to insert into meat. The stakes are perforated to allow marinade to infuse into meat. The marinade is stored in a fluid reservoir being connected to the infusers by a conduit (tube). Multiple infusers are contained in a cooking unit.

7. U.S. Pat. No. 8,443,722 discloses a marinade appliance that hangs down beneath the grill where cooking grease would drip on it. A container has vent holes that are not variable. The fluid vaporizes out the vent holes.

What is needed in the art is a simple, above the grill, heat resistant vaporizing container that adds flavoring and/or water vapors to the cooked food during the barbequing process.

The present invention provides a (preferably metal) tube with a plurality of holes along the top. Sliding dampers allow adjustment of the openings of the holes. Various designs to provide disassembly for dishwasher cleaning after use are provided.

### SUMMARY OF THE INVENTION

The main aspect of the present invention is to provide a simple water container that can be placed on top of a grill such that water (including flavored water and beer and other flavoring liquids) can be vaporized out a plurality of holes on top of the container during cooking.

Another aspect of the present invention is to provide a simple hole closure means to vary the size of each opening.

Another aspect of the present invention is to provide a variety of designs to allow a complete cleaning of the device after each use.

Other aspects of this invention will appear from the following description and appended claims, reference being made to the accompanying drawings forming a part of this specification wherein like reference characters designate corresponding parts in the several views.

Basically the design uses a copper pipe with a filler hole and various exit holes along a top surface. A flat bottom and/or legs allow the appliance to be put on top of a grill so as to stay in place. Each hole has a sliding damper to adjust the size of the hole for the escaping vapors. Safety designs include a stopper to prevent full closure of the holes and a tear down design for cleaning in a dishwasher.

### BRIEF DESCRIPTION OF THE DRAWINGS

FIG. 1 is a top perspective view of the vaporizer in place on a barbeque grill.

FIG. 2 is a side perspective view of the vaporizer.

FIG. 3 is a top plan view of the vaporizer without the dampers.

FIG. 4 is a side elevation view of the vaporizer without the dampers.

FIG. 5 is an exploded view of a vaporizer embodiment that comes apart for cleaning.

FIG. 6 is a top plan view of the FIG. 5 embodiment.

FIG. 7A is a front elevation view of a stand 70.

FIG. 7B is a side elevation view of a leg 72 of the stand 70.

FIG. 7C is a top perspective view of the stand 70.

FIG. 7D is a side perspective view of the marinade appliance with the stand 70.

FIG. 8 is a side perspective view of a damper.

FIG. 9 is a top plan view of a sheet metal segment used to form the damper of FIG. 8.

FIG. 10 is an exploded view of a alternate embodiment marinade appliance.

FIG. 11 is a side elevation view of a hinged embodiment.

Before explaining the disclosed embodiment of the present invention in detail, it is to be understood that the invention is not limited in its application to the details of the particular arrangement shown, since the invention is capable of other embodiments. Also, the terminology used herein is for the purpose of description and riot of limitation.

### DETAILED DESCRIPTION OF THE DRAWINGS

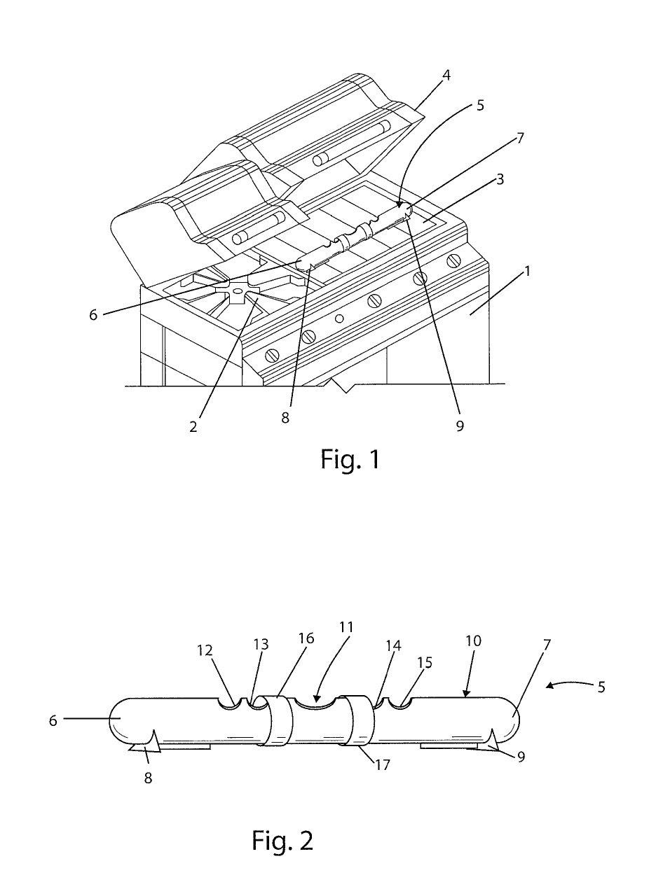

Referring first to FIGS. 1, 2 an outdoor barbeque 1 has a gas burner 2 and a grill 3 above the gas burner 2. When the hood 4 is closed an oven is formed over the grill 3. The marinade container 5 is essentially a (copper) tube closed at both ends 6, 7.

Feet 8, 9 prevent the marinade container 5 from rolling. A top surface 10 has a fill hole 11 into which water or beer or any flavoring liquid may be poured. Vaporizing outlet holes 12, 13, 14, 15 are shown. The holes 13 and 14 each have a sliding damper 16, 17 respectively. Thus, the chef can adjust the amount of vapor escaping into his oven during his cooking cycle.

Various safety designs are possible to prevent a complete blockage of vapor outlet holes. This embodiment simply does not have enough sliding dampers to cover all the holes 11, 12, 13, 14, 15. Other designs could use stoppers to prevent full closure of the damper, or the fill hole 11 could simply never be covered by any damper. There exist endless combinations of designs to prevent a complete coverage of all outlet holes.

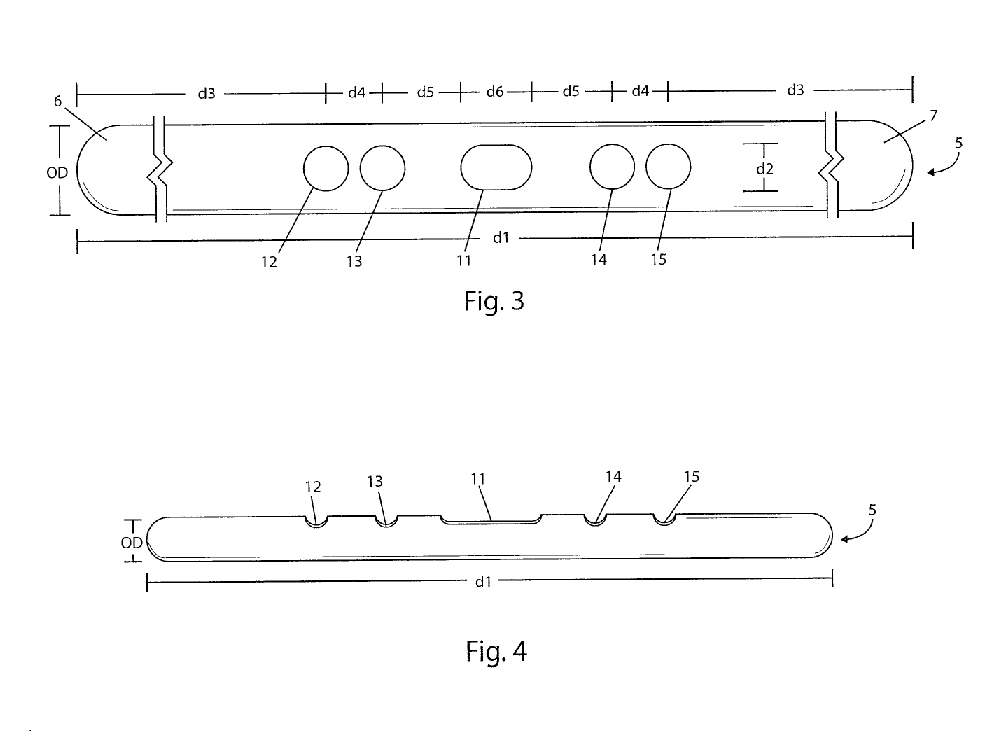

Referring next to FIGS. 3, 4 various dimensions for this sixteen inch marinade container are shown. In reality the present invention covers any length marinade container. The container could be of many shapes including U shaped, circular like a donut, square, rectangular and triangular. This embodiment 5 can be a 1″ copper pipe with spun (closed) ends 6, 7. Nominal dimensions include: d1=16″; d2=0.5″; d3=4.25″; d4=1.5″; d5=1.375″; d6=1.75″. This embodiment 5 is made from a type M copper pipe having an OD.=1.125″, and I.D.=1.055″, a wall thickness=0.035″.

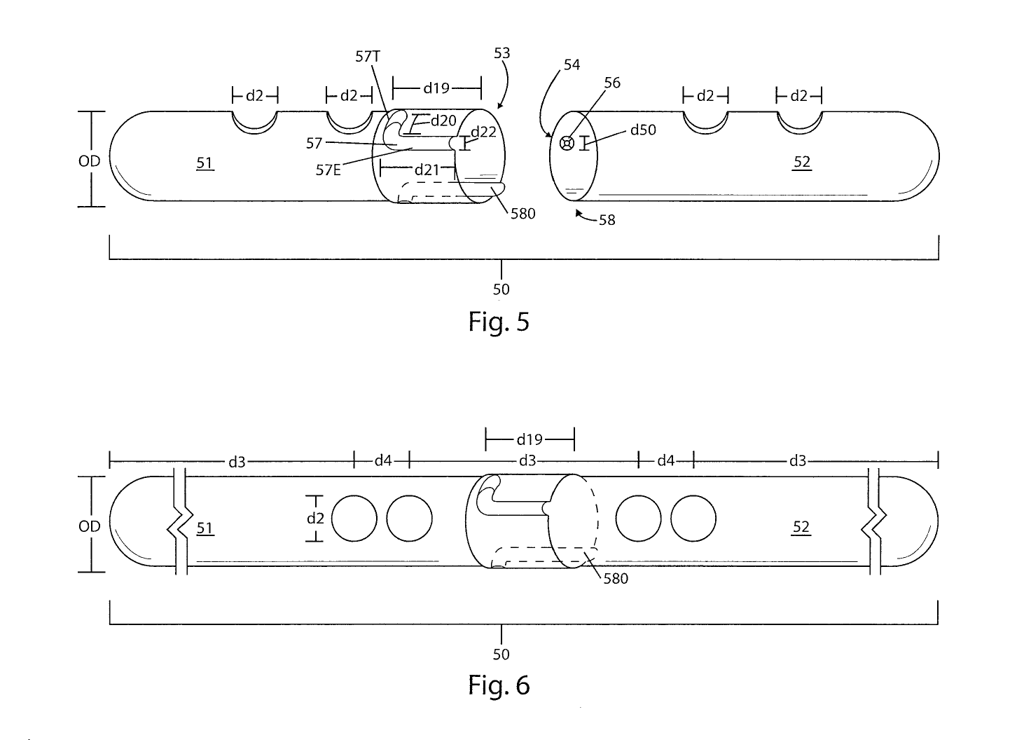

Referring next to FIGS. 5, 6 a two piece marinade appliance 50 is designed to enable the chef to break apart segment 51 from segment 52. Then the chef can put openings 53 and 54 l onto prongs in a dishwasher for complete cleaning after each use. This embodiment uses a pair of bosses 56A, 56B rising above the surface of segment 52 at an inside/locking end 58. The nominal height of each boss 56A, 56B is 7/32 inch with a diameter of 7/32″=d50.

The segment 51 has a pair of locking channels 57, 580. Nominal dimensions are d19=1″, d20=⅜″, d21=⅞″, d22=¼″. Each locking channel has a right angle locking tip labeled 57T which has a slight taper to lock the base 56. The elongate channel 57E has a uniform diameter d22. Equivalent locking designs include threaded members 51, 52 (not shown), and clip (not shown).

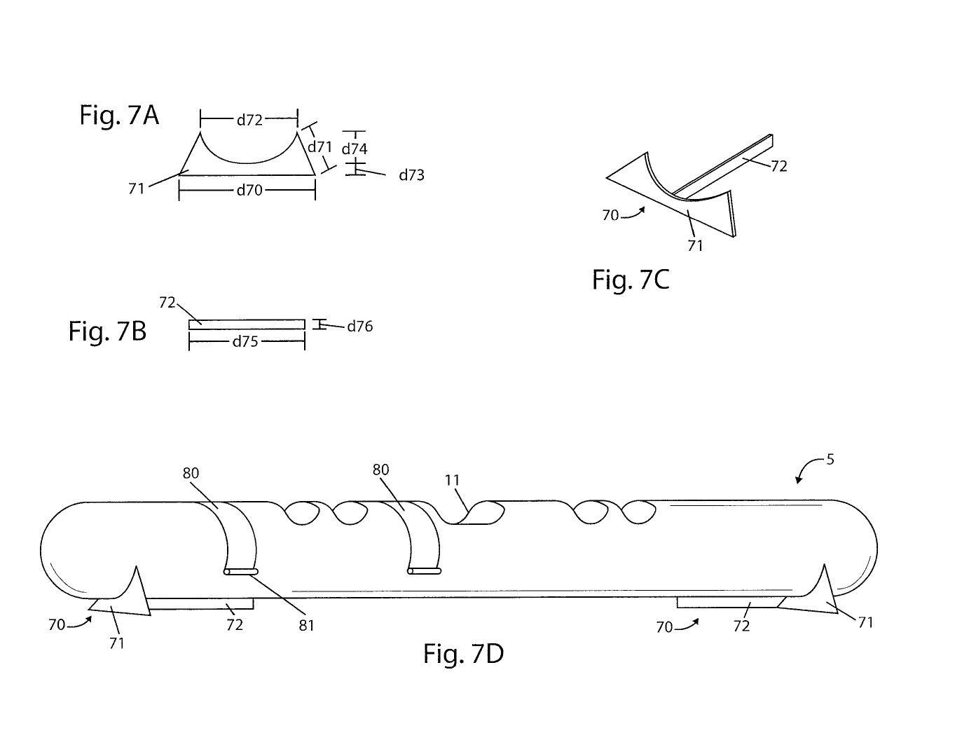

Referring next to FIGS. 7A-7D one type of anti-roll device is shown to be stand 70. Equivalent designs include a flat bottom, wings and others. The stand 70 has a concave section 71 connected to a leg 72. These parts 71, 72 can be made of copper and welded to the marinade appliance 5. Nominal dimensions are d70=1.5″, d71=0.5″, d72=1 1/32″, d73= 3/16″, d74=⅝″, d75=1.25″, d76= 3/16″.

The sliding damper 80 has a safety folded over lip 81. Each exit hole could have one. For safety at least one hole such as 11 must remain open to prevent an explosion. Other equivalent designs could include stoppers (not shown) to prevent a damper 80 from totally sealing a hole.

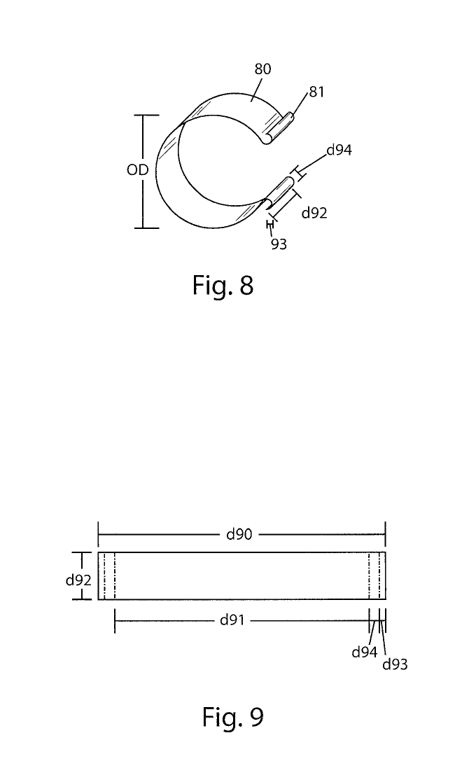

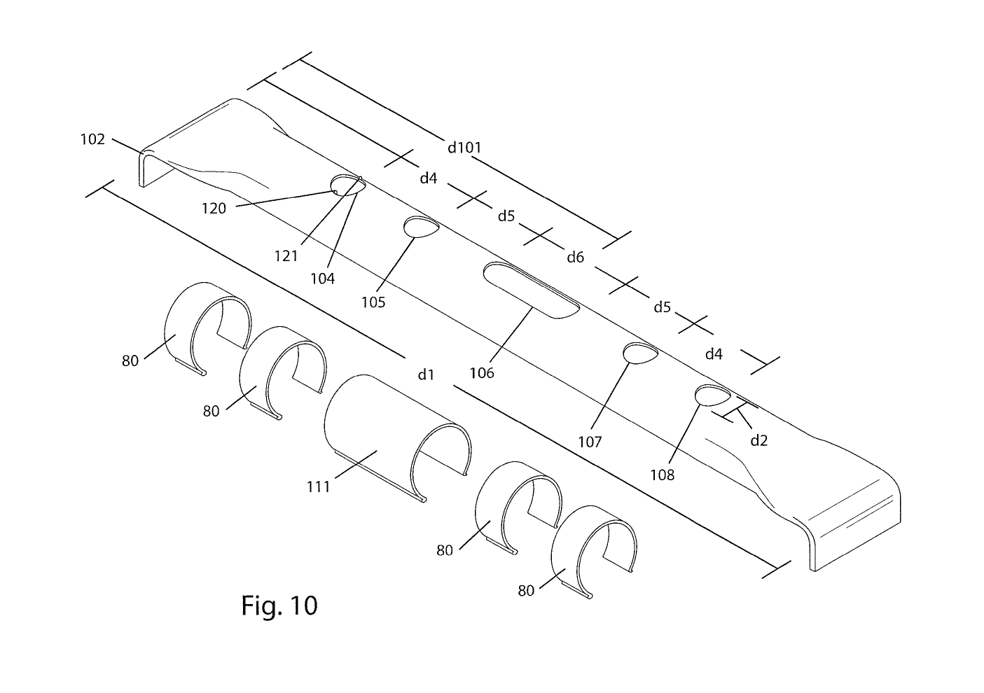

FIGS. 8, 9 show nominal dimensions of d90=3⅛″, d91=2½″, d92= 9/16″, d93= 1/16″, d94=⅛″.

Referring last to FIG. 10 a marinade appliance 100 has a cylindrical central body 101 preferably made of copper. Each end tapers into a hook bracket 102, 103 for stabilizing on top of a flat surface. A central hole 106 can be opened/closed by sliding damper 111. Holes 104, 105, 107, 108 can be opened/closed by the appropriate sliding damper 80. Stoppers 120, 121 prevent a total closure of hole 104, thereby preventing an explosion. Other safety measures including sizing at least one sliding damper smaller than the vent hole it covers are not shown.

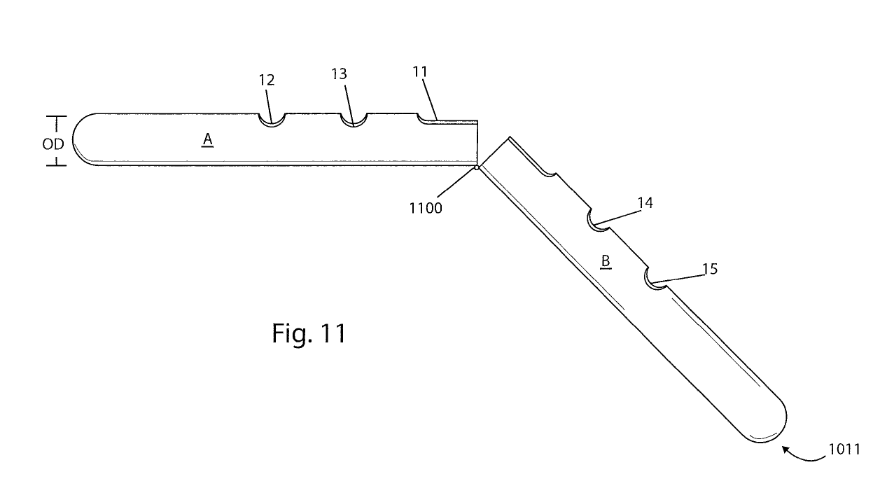

In FIG. 11 a hinge 1100 serves to join halves A and B so as to provide a disassembled mode. This embodiment is labeled 1011.

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

I claim:

1. A marinade appliance comprising:
a cylindrical hollow container having a base means functioning to provide a stand on top of a grill;
a top of the cylindrical hollow container having a fill port;
a plurality of vent holes on the top of the cylindrical hollow container;
at least one vent hole having a sliding damper to adjust a size of the vent hole; and
a two part design to enable a tear down of the cylindrical hollow container for washing.

2. The appliance of claim 1, wherein the base means further comprises a T shaped stand attached at each bottom end of the hollow container, the T shaped stand having a concave foot to attach to a bottom of the hollow container, the concave foot running transverse to the longitudinal axis of the hollow container, and a shaft extending perpendicular to the concave foot for attachment to a bottom of the hollow container.

3. The appliance of claim 1, wherein the at least one sliding damper further comprises a flat rounded spring clip at least as wide as the vent hole it covers.

4. The appliance of claim 1, wherein the at least one sliding damper further comprises a flat, rounded spring clip narrower than the vent hole it covers to prevent an explosion.

5. The appliance of claim 1, wherein the at least one vent hole further comprises a stopper that prevents a total closure of the vent hole by the sliding damper.

6. The appliance of claim 1, wherein the two part design further comprises a first end with a groove and a second end with a boss that slides into the groove and locks in the groove by twisting the boss relative to the groove so as to nest the boss in a notch at a distal end of the groove.

7. The appliance of claim 1, wherein the cylindrical hollow container has a smooth circular cross section.

8. The appliance of claim 1 further comprising a central vent hole with a width of at least twice that of an off center vent hole located toward each end of the cylindrical hollow container.

9. The appliance of claim 8, wherein each vent hole has a sliding damper end at least one vent hole has a means to prevent a total closure functioning to always leave an escape hole for expanding gases.

10. A marinade container comprising:
an elongate container having a base means functioning to stabilize said container on a flat surface;
said elongate container having a liquid fill hole on a top surface;
said elongate container having a plurality of vent holes on the top surface;
at least one of said vent holes having an adjustable damper; and
said container having a disassembled mode to enable washing in a dishwasher.

11. The container of claim 10, wherein the base means further comprises a tapered end at each end of the elongate container wherein each tapered end folds into a flat stand at a transverse axis to a longitude axis of the elongate container.

12. The container of claim 11, wherein the elongate container further comprises a hollow cylindrical container with a smooth circular cross section.

13. The container of claim 10, wherein the disassembled mode further comprises a hinge connecting a left and a night end of the elongate container.

14. A marinade container comprising:
a cylindrical elongate hollow cupper tube having a length ranging from about fourteen inches to about sixteen inches;
said tube having a top central vent hole at least two round vent holes toward each end, each hole at least a quarter inch in diameter;
each vent hole having a sliding damper made of a flat spring semi-circular enclosure;
at least one vent hole having a closure preventer means functioning to prevent the sliding clamper from completely closing the vent hole; and
a bottom of the tube having an anti-roll means functioning to maintain the tube in an upright position, vent holes up, when placed on a grill and flat surface.

15. The container of claim 14, wherein the closure preventer means further comprises a stop adjacent of claim 14, wherein the closure prevents means further comprises a stop adjacent the vent hole.

16. The container of claim 14, wherein the anti-roll means further comprises a tapered end at each end of the tube which flattens into a downward facing foot.
